(19) United States
(12) Patent Application Publication
(10) Pub. No.: US 2010/0223843 A1
(43) Pub. Date: Sep. 9, 2010

(54) INCREASING VITAMIN D CONTENT OF MUSHROOMS WITH UV LIGHT

(75) Inventor: Roger Williams, Acton, MA (US)

Correspondence Address: WILMERHALE/BOSTON, 60 STATE STREET, BOSTON, MA, 02109, US

(73) Assignee: Xenon Corporation, Wilmington, MA (US)

(21) Appl. No.: 12/716,936

(22) Filed: Mar. 3, 2010

Related U.S. Application Data
(60) Provisional application No. 61/156,972, filed on Mar. 3, 2009.

(51) Int. Cl. A01G 1/04

(52) U.S. Cl. 47/1.1

(57) ABSTRACT

The vitamin D content of a mushroom can be increased by exposing the mushroom to a lamp that emits UVA and UVB, but not UVC radiation. The need for ozone ventilation is eliminated by utilizing a lamp that does not emit the shorter UVC wavelengths.

### CROSS-REFERENCE TO RELATED APPLICATION

This application claims priority under 35 U.S.C. Section 119(e) to Application Ser. No. 61/156,972, filed Mar. 3, 2009, which is incorporated herein by reference.

### BACKGROUND

Exposing mushrooms to UV light can increase the amount of vitamin D in the mushrooms. Both continuous mercury lamps and pulsed xenon lamps can be used in this process. The lamps used in this process are constructed with clear quartz envelopes to enable the transmission of the UV rays. These lamps emit UVA, UVB, and UVC rays. Lamps that generate the full UV spectra are classified as type C lamps. Pulsed lamps can generate significantly less heat than continuous mercury lamps.

The changes that occur when mushrooms are exposed to ultraviolet light are well understood. Vitamin D is a fat-soluble vitamin commonly occurring in two forms: D₂ (ergocalciferol) and D₃ (cholecalciferol). Vitamin D₂ is synthesized from the fungal sterol ergosterol through exposure to ultraviolet light. Vitamin D₃ is synthesized, in humans, through skin exposure to ultraviolet light and subsequent conversion of cholesterol.

Fungal sterol ergosterol is a class of organic molecules which occur naturally in both plants and animals. Ergosterol is a component of fungal cell membranes, serving the same function that cholesterol serves in animal cells. Ergosterol is a biological precursor to Vitamin D₂. It is turned into viosterol, a fat-soluble vitamin by ultraviolet light, and is then converted into ergocalciferol, vitamin D₂.

Ozone (O₃) is a toxic gas that spontaneous forms when UVC rays interact with the oxygen in the atmosphere (O₂). OSHA sets PPM human exposure limits for O₃. When type C lamps are operated in the in air, ozone is formed. To prevent the build up of O₃ in an enclosed space, special venting is required to remove the O₃ from the area.

### SUMMARY

The vitamin D content of a mushroom can be increased by exposing the mushroom to a lamp that emits UVA and UVB, but not UVC radiation. The need for ozone ventilation is eliminated by utilizing a lamp that does not emit the shorter UVC wavelengths. Other features and advantages will become apparent from the following description and claims.

### DESCRIPTION

Mercury UV lamps and pulsed UV xenon lamps can be fabricated with specialty quartz envelopes that have been doped to block the UVC radiation while still emitting the UVA and UVB rays. These lamps are referred to as type B lamps. Type B lamps do not generate ozone. As is generally known, the wavelengths for the different types of UV radiation are as follows: UVA is about 400 nm-320 nm, UVB is about 320 nm-290 nm, and UVC is about 290 nm-100 nm.

It has been discovered that when mushrooms are exposed to UV rays from a type B lamp, the increase in the vitamin D content of the mushroom is equal to or higher than the increase that is achieved with an equivalent type C lamp. Exposure tests were conducted using both portabella and whole white mushrooms. Groups of mushrooms were treated exclusively with a type C or a type B lamp. The treated mushrooms were sent to an outside laboratory where the level of vitamin D₂ contained in the mushroom samples was analyzed. The vitamin D₂ content found in each sample was measured in International Units (IU) per 100 grams of mushroom. A negligible amount of vitamin D₂ was found to be present in the untreated mushrooms. The average vitamin D₂ content for mushrooms treated with a single pulse of light from a type C lamp increased to 191 IU/100 grams. The average vitamin D₂ level for mushrooms treated with a single pulse of light from a type B lamp increased to 278 IU/100 grams. See Tables 1 and 2 below.

Type B lamps do not induce the formation of ozone gas. The elimination of this gas enhances worker safety and eliminates the cost and complexity of removing this gas from the production environment.

In the tables below, each sample (other than control) used 505 joules/pulse, and the mushroom was 1.25 inches (3.1 cm) from the lamp and oriented with its top up. Photographs showing aspects of the testing are in the incorporated provisional application.

TABLE 1

| | | | | Inches | | | |
|---|---|---|---|---|---|---|---|
| | | | | Diameter | Number | | |
| Sample | Mushroom | Weight | Temp | of | of | Distance | Lamp |
| # | type | Lbs | Deg F. | Mushroom | pulses | inches | Type |
| 1-port-1C | Portobello | 0.341 | 78 | 5.03 | 1 | 1.25″ | C |
| | whole | | | | | | |
| 2-port-2C | Portobello | 0.319 | 79 | 5.26 | 2 | 1.25″ | C |
| | whole | | | | | | |
| 3-port-3C | Portobello | 0.269 | 79 | 4.85 | 3 | 1.25″ | C |
| | whole | | | | | | |
| 4-port-2B | Portobello | 0.286 | 78 | 4.79 | 2 | 1.25″ | B |
| | whole | | | | | | |
| 5-port-control | Portobello | 0.335 | 79 | 4.9 | 0 | N/A | N/A |
| | whole | | | | | | |
| 6-white-1C | 4- White whole | 0.24 | 71 | 2.2 | 1 | 1.25″ | C |
| 7-white-2C | 4- White whole | 0.278 | 70 | 2.3 | 2 | 1.25″ | C |
| 8-white-3C | 4- White whole | 0.268 | 71 | 2.17 | 3 | 1.25″ | C |
| 9-white-2B | 4- White whole | 0.241 | 71 | 2.12 | 2 | 1.25″ | B |
| 10-white- | 4- White whole | 0.228 | 70 | 2.11 | 0 | N/A | N/A |
| control | | | | | | | |

TABLE 2

| | J/CM\hat{ }2 | J/CM\hat{ }2 | J/CM\hat{ }2 | J/CM\hat{ }2 | | | | |
|---|---|---|---|---|---|---|---|---|
| | BB | BB | Act - 5 | Act - 5 | | | IU/100 g/ | IU/100 g/ |
| Lamp | Energy | Energy | Sed 240 | Sed 240 | | IU/100 g/ | control | pulse |
| Type | read/pulse | Integrated | Read/pulse | Integrated | IU/100 g | pulse | Portobello | B VS C |
| C | 1.12 | 1.12 | 0.0319 | 0.0319 | 184 | 184 | 9.2 | 1.511 |
| C | 1.12 | 2.24 | 0.0319 | 0.0638 | 383 | 191.5 | 19.15 | 1.452 |
| C | 1.12 | 3.36 | 0.0319 | 0.0957 | 374 | 125 | 18.7 | 2.230 |
| B | 0.873 | 1.746 | 0.0343 | 0.0686 | 556 | 278 | 27.8 | 1.000 |
| N/A | | | | | 20 | N/A | 1 | |
| | J/CM\hat{ }2 | J/CM\hat{ }2 | J/CM\hat{ }2 | J/CM\hat{ }2 | | | | |
| | BB | BB | Act - 5 | Act - 5 | | | IU/100 g/ | IU/100 g/ |
| Lamp | Energy | Energy | Sed 240 | Sed 240 | | IU/100 g/ | control | pulse |
| Type | read/pulse | read/pulse | Read/pulse | Integrated | IU/100 g | pulse | Portobello | B VS C |
| C | 1.12 | 1.12 | 0.0319 | 0.0319 | 674 | 674 | 33.7 | 1.0460 |
| C | 1.12 | 2.24 | 0.0319 | 0.0638 | 1670 | 835 | 83.5 | 0.8443 |
| C | 1.12 | 3.36 | 0.0319 | 0.0957 | 1770 | 590 | 88.5 | 1.1949 |
| B | 0.873 | 1.746 | 0.0343 | 0.0686 | 1410 | 705 | 70.5 | 1.0000 |
| N/A | | | | | 20 | N/A | 1 | |

What is claimed is:

1. A method for irradiating mushrooms with ultraviolet (UV) radiation, the method comprising irradiating mushrooms with a UV Type B lamp, the UV Type B lamp providing UVA and UVB radiation, but blocking UVC radiation, the method increasing the vitamin D content of the mushroom without generating ozone gas.

2. The method of claim 1, wherein the UV Type B lamp is a pulsed lamp.

3. The method of claim 1, wherein the UV Type B lamp provides two pulses.

4. A method for irradiating mushrooms with ultraviolet (UV) radiation, the method comprising irradiating mushrooms with a lamp that provides UVA and UVB radiation while not using radiation that generates ozone gas, the method increasing the vitamin D content of the mushroom without generating ozone gas.

5. The method of claim 4, wherein the lamp is a pulsed lamp.

6. The method of claim 4, wherein the lamp provides two pulses.

7. An apparatus comprising a pulsed lamp system having a UV Type B lamp in combination with a mushroom for increasing the vitamin D content of the mushroom without generating ozone gas.

8. The method of claim 7, wherein the lamp is a pulsed lamp.
